(19) United States
(12) Patent Application Publication
(10) Pub. No.: US 2026/0100998 A1
(43) Pub. Date: Apr. 9, 2026

(54) DEVICE, METHOD AND SYSTEM FOR MUTING SPEAKERS OF COMMUNICATION DEVICES OF A MAIN TALKGROUP WHEN PROVIDING AUDIO VIA A HUB DEVICE

(71) Applicant: MOTOROLA SOLUTIONS, INC., Chicago, IL (US)

(72) Inventors: Haim KAHLON, Airport City (IL); Maor HADAD, Airport City (IL); Guy BURKO, Airport City (IL)

(21) Appl. No.: 18/909,330

(22) Filed: Oct. 8, 2024

(51) Int. Cl. H04M 1/72412; H04W 4/10

(52) U.S. Cl. CPC H04M 1/72412; H04W 4/10

(57) ABSTRACT

A hub device associated with a vehicle determines: communication devices presently in communication with the hub device; and respective selected talkgroups associated with the communication devices. As a number of the communication devices in communication with the hub device changes, the hub device dynamically changes a main talkgroup chosen from the respective selected talkgroups based on information associated with one or more of: the communication devices; the respective selected talkgroups; and users associated with the communication devices. When a call is received on the main talkgroup, the hub device: controls speakers, of respective communication devices associated with the main talkgroup, to mute; and provides audio of the call via a hub device speaker.

### BACKGROUND

When multiple adjacent communication devices are providing audio from a same talkgroup, for example on respective speakers, and a microphone of one the communication devices is being used to communicate on the talkgroup, feedback may occur as audio input to the microphone may be emitted on the other speakers and back into the microphone. Such feedback causes a howling effect within the audio in the talkgroup.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a system for muting speakers of communication devices of a main talkgroup when providing audio via a hub device, in accordance with some examples.

FIG. 2 is a device diagram showing a device structure of a device for muting speakers of communication devices of a main talkgroup when providing audio via a hub device, in accordance with some examples.

FIG. 3 is a flowchart of a method for muting speakers of communication devices of a main talkgroup when providing audio via a hub device, in accordance with some examples.

FIG. 4 depicts a signal flow showing the system of FIG. 1 implementing aspects of a method for muting speakers of communication devices of a main talkgroup when providing audio via a hub device, in accordance with some examples.

FIG. 5 depicts a signal flow showing the system of FIG. 1 implementing further aspects of a method for muting speakers of communication devices of a main talkgroup when providing audio via a hub device, in accordance with some examples.

FIG. 6 depicts the system of FIG. 1 implementing further aspects of a method for muting speakers of communication devices of a main talkgroup when providing audio via a hub device, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Talkgroups are generally used by first responders communicating via communication devices, such as radios and/or land mobile radios and/or digital mobile radios, and the like. Howling in audio of a talkgroup may occur when communication devices in the talkgroup are in close proximity; such a situation may occur when a plurality of first responders, such as police officers, are located in a same vehicle, such as a police vehicle, and audio from the talkgroup is being output on at least two speakers in the vehicle. In particular, such vehicles may include a hub device through which talkgroup communications for the communication devices in the vehicle may be routed. Such a hub device may, for example, comprise a vehicle hub communication device and/or a radio. While such a hub device is convenient, when the hub device routes the audio through associated hub device speaker, such as vehicle speakers, and the audio is also provided at speakers of a communication device, the howling may occur. The situation may be further complicated by the hub device routing audio for more than one talkgroup to the communication devices in the vehicle, and by the number of the communication devices in the vehicle changing. Thus, there exists a need for an improved technical method, device, and system for muting speakers of communication devices of a main talkgroup when providing audio via a hub device.

An aspect of the present specification provides a method comprising: determining, at a hub device associated with a vehicle: communication devices presently in communication with the hub device; and respective selected talkgroups associated with the communication devices; as a number of the communication devices in communication with the hub device changes, dynamically changing, via the hub device, a main talkgroup chosen from the respective selected talkgroups based on information associated with one or more of: the communication devices; the respective selected talkgroups; and users associated with the communication devices; and when a call is received on the main talkgroup: controlling, via the hub device, speakers, of respective communication devices associated with the main talkgroup, to mute; and providing, via the hub device, audio of the call via a hub device speaker.

Another aspect of the present specification provides a hub device associated with a vehicle, the hub device comprising: a controller; and a computer-readable storage medium having stored thereon program instructions that, when executed by the controller, causes the controller to perform a set of operations comprising: determining: communication devices presently in communication with the hub device; and respective selected talkgroups associated with the communication devices; as a number of the communication devices in communication with the hub device changes, dynamically changing a main talkgroup chosen from the respective selected talkgroups based on information associated with one or more of: the communication devices; the respective selected talkgroups; and users associated with the communication devices; and when a call is received on the main talkgroup: controlling speakers, of respective communication devices associated with the main talkgroup, to mute; and providing audio of the call via a hub device speaker.

Each of the above-mentioned embodiments will be discussed in more detail below, starting with example system and device architectures of the system in which the embodiments may be practiced, followed by an illustration of processing blocks for achieving an improved technical method, device, and system for muting speakers of communication devices of a main talkgroup when providing audio via a hub device.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions and/or program code and/or computer program code. These computer program instructions and/or program code may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions and/or program code may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions and/or program code may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Herein, reference will be made to engines, which may be understood to refer to hardware, and/or a combination of hardware and software (e.g., a combination of hardware and software includes software hosted at hardware such that the software, when executed by the hardware, transforms the hardware into a special purpose hardware, such as a software module that is stored at a processor-readable memory implemented or interpreted by a processor), or hardware and software hosted at hardware and/or implemented as a system-on-chip architecture and the like.

Further advantages and features consistent with this disclosure will be set forth in the following detailed description, with reference to the drawings.

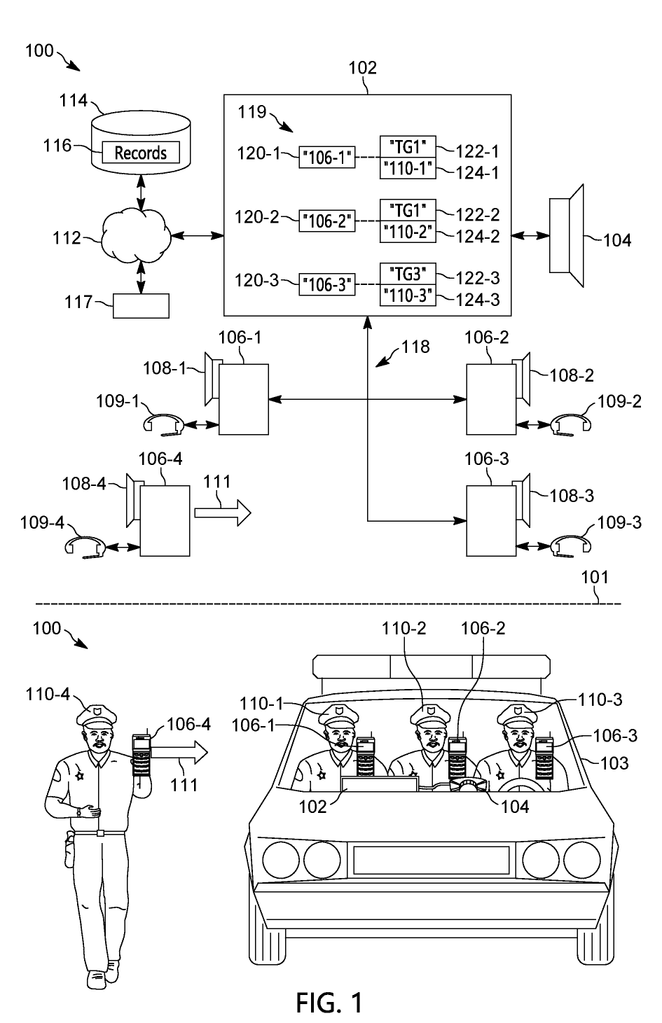

Attention is directed to FIG. 1, which depicts an example system 100 for muting speakers of communication devices of a main talkgroup when providing audio via a hub device. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like, unless otherwise indicated.

Furthermore, FIG. 1 depicts details of the system 100 above a dashed line 101, and depicts a physical deployment and/or location of a portion of components of the system 100 below the dashed line 101.

The system 100 comprises a hub device 102, which as depicted, may comprise a vehicle hub communication device and/or a dashboard communication device and/or a dashboard radio of a vehicle 103 and, in particular, as depicted, a police vehicle. The hub device 102 is communicatively coupled with at least one hub device speaker 104, which may, for example as depicted, comprise a speaker mounted in a dashboard of the vehicle 103.

The system 100 further comprise a plurality of communication devices 106-1, 106-2, 106-3, 106-4, interchangeably referred to hereafter, collectively, as the communication devices 106 and, generically, as a communication device 106. This convention will be used throughout the present specification.

As best seen above the dashed line 101, the communication devices 106 comprise respective speakers 108-1, 108-2, 108-3, 108-4 (e.g., speakers 108 and/or a speaker 108), which may be used to output audio of talkgroup communications received at a respective communication device 106. While the speakers 108 are depicted as extending from the communication devices 106 to emphasized their presence at the communication devices 106, the speakers 108 are generally understood to be integrated within respective housings of the communication devices 106. While not depicted, a communication device 108 may comprise a remote-speaker microphone (RSM), and a respective speaker 108 may comprise a component of such an RSM.

As depicted, the communication devices 106 may comprise, or be connected to (e.g., via respective wired or wireless communication links) respective headsets 109-1, 109-2, 109-3, 109-4 (e.g., headsets 109 and/or a headset 109), which may comprise headset speakers and a headset microphone, and the headset speakers may be used to output audio of talkgroup communications received at a respective communication device 106.

The headsets 109 are, however, understood to be optional, and respective speakers 108 may be the default audio output for the communication devices 106. For example, the respective speakers 108 may be integrated into respective housings of the communication devices, along with respective microphones (not depicted) that may be the default audio input for the communication devices 106.

Furthermore, while not depicted, the communication devices 106 may comprise, or be connected to (e.g., via respective wired or wireless communication links), earpieces that may be used to output audio of talkgroup communications received at a respective communication device 106. In some examples, speakers of the headsets 109 may represent such earpieces.

Furthermore, as depicted, the communication devices 106 may be operated by respective users 110-1, 110-2, 110-3, 110-4 (e.g., users 110 and/or a user 110). While the users 110 are depicted as police officers, the users 110 may comprise any suitable users, such as other types of first responders (e.g., firefighters, emergency medical technicians, security guards, amongst other possibilities), and the like, with the vehicle 103 adapted accordingly. However, the users 110 may be any suitable combination of users equipped with the communication devices 106 that generally use talkgroups for communicating as described herein, and the vehicle 103 may comprise any suitable type of corresponding vehicle.

Furthermore, from FIG. 1, it is understood that three of the officers 110-1, 110-2, 110-3 are located in the vehicle 103, and are operating their respective communication devices 106-1, 106-2, 106-3 in the vehicle 103, whereas a fourth officer 110-4, operating a respective communication device 106-4, is approaching the vehicle 103 and/or the hub device 102, as indicated by arrows 111. The fourth officer 110-4 may generally enter the vehicle 103.

As depicted, the hub device 102 is communicatively coupled with one or more communication networks 112 (e.g., for simplicity, hereafter the network 112), and the hub device 102 may optionally be communicatively coupled, via the network 112, with a memory 114 storing records 116. Alternatively, or in addition, at least a portion of the records 116 may be stored at a memory of the hub device 102. The records 116 may store information relate to the communication devices 106 and/or the users 110 and/or incidents as described herein. Hence, the records 116 may include, but are not limited to: communication device records, employee records, incident reports and/or records, and the like. While not depicted, the system 100 may comprise other communication devices communicatively coupled to the network 112, and which may communicate with the communication devices 106 via the network 112 using talkgroups.

As depicted, the communication devices 106 comprise radios, such as land-mobile radios, digital mobile radios, and the like, which are understood to communicate via talkgroups, in either a conventional or trunked configuration. In either configuration, a plurality of communication devices (e.g., which may include the hub device 102, the communication devices 106 and/or other communication devices, such as a remote communication device 117 communicatively coupled to the network 112), are partitioned into separate groups (talkgroups) of communication devices. In a conventional narrowband system, each communication device in a group is tuned to a particular radio channel (frequency or frequency & time slot) for communications associated with that communication device’s group. Thus, each group is served by one channel, and multiple groups may share the same single frequency (e.g., in which case, in some examples, group IDs (identifiers) may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Using talkgroups, group calls may be made between communication devices via wireless transmissions in accordance with either a narrowband or a broadband protocol and/or standard, with the network 112 adapted accordingly. Group members for group calls may be statically or dynamically defined. That is, in a first example, a user or administrator may indicate to a switching and/or radio network (such as at a call controller, push-to-talk (PTT) server, zone controller, or mobile management entity (MME), base station controller (BSC), mobile switching center (MSC), site controller, push-to-talk (PTT) controller, or other network device) a list of participants of a group at the time of the call or in advance of the call. The group members (e.g., communication devices) may be provisioned in a network by the user or an agent, and then provided with some form of group identity or identifier, for example, which is be referred to herein as a talkgroup identifier (ID). Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) based on user input, and the switching and/or radio network may track group membership and route new group calls according to the current group membership.

Hence, the communication devices 106 may be members of any suitable number of talkgroups, and input devices at the communication devices 106 may be operated by the users 110 to select a talkgroup for current use at a communication device 106. Such a talkgroup that is selected at a communication device 106 is referred to herein as a selected talkgroup. It is understood that there may or may not be active communications occurring on a selected talkgroup; rather, a selected talkgroup comprises a talkgroup that an associated communication device 106 is presently tuned to and/or listening to, in the event that communications do occur on the selected talkgroup, and/or in the event a respective user 110 may wish to communicate with the selected talkgroup, for example by actuating a PTT button at the associated communication device 106.

Hence, the network 112 may comprise a network suitable for talkgroup communications and, while not depicted for simplicity, any of the communication devices 106 may initiate a wireless communication link with the network 112 to perform such talkgroups communications.

Alternatively, as depicted, the hub device 102 may act as a hub (e.g., a proxy) for such talkgroup communications, for example forming local communication links 118 with the communication devices 106 when, for example, respective users 110 and their respective communication devices 106 are located in the vehicle 103, and/or when the respective communication devices 106 are within a given range from the hub device 102 (e.g., 1 meter, 2 meters, 5 meters, amongst other possibilities), whether inside or outside the vehicle 103. However, in specific examples, the hub device 102 may form local communication links 118 with the communication devices 106 when, for example, respective users 110 and their respective communication devices 106 are located in the vehicle 103, and disconnect a respective local communication link 118 when a respective user 110 and their respective communication device 106 is located outside the vehicle 103.

Such local communication links 118 may comprise any suitable wireless communication link that may include, but is not limited to, WiFi communication links, Bluetooth™ communication links, proprietary wireless communication links (e.g., that may be particular to a manufacturer of the hub device 102 and the communication devices 106), and the like. It is hence understood that a local communication link 118 may be formed when a communication device 106 is within the given range of the hub device 102. However, in some examples, a local communication link 118 may not be formed until a communication device 106 is determined to be inside the vehicle 103, as described in more detail below.

Furthermore, while as depicted, the local communication links 118 may be between the hub device 102 and all the communication devices 106-1, 106-2, 106-3 located in the vehicle 103, such local communication links 118 may comprise respective wireless communication links between the hub device 102 and each of the communication devices 106-1, 106-2, 106-3.

In FIG. 1, however, the fourth communication device 106-4 is not in communication with the hub device 102, but a local communication link 118 may be formed between the hub device 102 and the fourth communication device 106-4, when the fourth communication device 106-4 is within the given range of the hub device 102 and, more specifically, when the fourth user 110-4 and the fourth communication device 106-4 are located in the vehicle 103.

Furthermore, it is understood that the communication devices 106 register with the hub device 102, for example in conjunction with forming local communication links 118 therewith, and/or when the communication devices 106 connect with the hub device 102 (e.g., via local communication link 118). Such registration may occur via receiving connection information and/or registration data from the communication devices 106.

For example, as depicted, the hub device 102 has stored respective registration data 119 for the three communication devices 106-1, 106-2, 106-3 that include:

Respective device identifiers 120-1, 120-2, 120-3 (e.g., device identifiers 120 and/or a device identifier 120) of the communication devices 106-1, 106-2, 106-3. While the device identifiers 120 are indicated with respective text “106-1”, “106-2”, “106-3”, the device identifiers 120 may include any suitable device identifiers including, but not limited to, a radio identification number (that may be assigned to the communication devices 106 by an entity that manages the communication devices 106 and/or the users 110, such as a first responder entity), a media access control address (MAC) address, and/or any other suitable identifier. Alternatively, or in addition, device identifiers 120 may comprise an identifier that may be used to search the records 116 to determine any other suitable information, associated with a respective communication device 106.

Respective talkgroup identifiers 122-1, 122-2, 122-3 (e.g., talkgroup identifiers 122 and/or a talkgroup identifier 122) of associated selected talkgroups at the communication devices 106-1, 106-2. While the talkgroup identifiers 122 are indicated with respective text “TG1” “TG3, etc. (e.g., for “Talkgroup 1”, “Talkgroup 3”, the talkgroup identifiers 122 may include any suitable talkgroup identifiers that may be assigned to talkgroups by an entity that manages the communication devices, and/or in any other suitable manner. Furthermore, the talkgroup identifiers 122 may comprise an identifier that may be used to search the records 116 to determine an incident that a respective talkgroup may be assigned to.

Respective user identifiers 124-1, 124-2, 124-3 (e.g., user identifiers 124 and/or a user identifier 124) of associated users 110-1, 110-2, 110-3 the communication devices 106-1, 106-2. While the user identifiers 124 are indicated with respective text “110-1”, “110-2”, “110-3”, the user identifiers 124 may include any suitable user identifiers including, but not limited to, badge number, an employee number, a name, and the like, and/or any other suitable identifier, which may include a rank of a respective user 110. Alternatively, or in addition, the user identifiers 124 may comprise an identifier that may be used to search the records 116 to determine a rank, and/or any other suitable information, associated with a respective user 110.

Furthermore, such registration data 119 may be stored at the hub device 102 when a communication device 106 disconnects therefrom, though a respective talkgroup identifier 122 may be deleted from the registration data 119, and repopulated when a communication device 106 later connects to the hub device 102.

Respective associations between the identifiers 120, 122, 124 are indicated in FIG. 1 via broken lines therebetween.

As depicted, the device identifier 120-1 of the first communication device 106-1 is associated with a selected talkgroup identifier 122-1 of “TG1”, indicating that a “Talkgroup 1” is selected at the first communication device 106-1.

Similarly, the device identifier 120-2 of the first communication device 106-2 is associated with a selected talkgroup identifier 122-2 of “TG1”, indicating that a “Talkgroup 1” is selected at the second communication device 106-2. Put another way, as depicted, a talkgroup “Talkgroup 1” has been selected at both the communication devices 106-1, 106-2.

Similarly, the device identifier 120-3 of the first communication device 106-3 is associated with a selected talkgroup identifier 122-3 of “TG3”, indicating that a “Talkgroup 3” is selected at the third communication device 106-3. Hence, a different talkgroup has been selected at the third communication device 106-3 than the other communication devices 106-1, 106-2.

Furthermore, when a given communication device 106 is operated to change a selected talkgroup, the given communication device 106 may communicate the talkgroup identifier 122 of the selected talkgroup to the hub device 102, which updates an associated talkgroup identifier 122 accordingly.

Once a communication device 106 has connected and registered with the hub device 102, communications on the selected talkgroups may occur via the hub device 102, via the network 112 and a local communication link 118.

For example, when a first talkgroup is selected at the first and second communication devices 106-1, 106-2, the hub device 102 may relay communications between the communication devices 106-1, 106-2 and the network 112 on the first talkgroup via the local communication links 118. Similarly, when a third talkgroup is selected at the third communication device 106-3, the hub device 102 may relay communications between the communication devices 106-3 and the network 112 on the third talkgroup via the local communication links 118. In this manner, the hub device 102 may act as a hub for talkgroup communications for connected (e.g., and registered) communication devices 106.

However, the hub device 102 may further determine a main talkgroup, of the selected talkgroups, and, when a call (e.g., a talkgroup communication) is received on the main talkgroup, the hub device 102: control speakers 108, of respective communication devices 106 (e.g., which may be as few as one communication device 106) associated with the main talkgroup, to mute; and provide audio of the call via the hub device speaker 104. In this manner, audio of the main talkgroup may be provided at the hub device speaker 104, and not at speakers 108 of communication devices 106 of the main talkgroup, thereby reducing and/or eliminating the aforementioned howl. Put another way, audio of the main talkgroup may be provided at one speaker within the vehicle 103, and in particular the hub device speaker 104.

The hub device 102 may choose a main talkgroup, from the respective selected talkgroups indicated by the talkgroup identifiers 122, based on information associated with one or more of: the communication devices 106; the respective selected talkgroups; and the users 110 associated with the communication devices.

For example, selection of a main talkgroup may be based on respective numbers of the communication devices 106 associated with respective selected talkgroups. In particular, a main talkgroup may be chosen by the hub device 102 based on which of the respective selected talkgroups is associated with a highest number of the communication devices 106. For example, in FIG. 1, as “Talkgroup 1” is associated with two communication devices 106-1, 106-2, and “Talkgroup 3” is associated with one communication devices 106-3, the hub device 102 may choose “Talkgroup 1” as the main talkgroup, as “Talkgroup 1” has a highest number of associated communication devices 106 of the selected talkgroups.

Alternatively, or in addition, selection of a main talkgroup may be based on ranks of the users 110. In particular, a main talkgroup may be chosen by the hub device 102 based on an associated user 110 having a highest rank. For example, when the user 110-3 enters the vehicle 103, and assuming that the user 110-3 has a rank that is higher than the users 110-1, 110-2, the hub device 102 may choose “Talkgroup 3” as the main talkgroup.

Alternatively, or in addition, selection of a main talkgroup may be based on an indication of a highest priority talkgroup, which may be received at the hub device 102 from the remote communication device 117, in communication with the network 112) and/or retrieved from the records 116 by the hub device 102, and the like. In particular, a main talkgroup may be chosen by the hub device 102 based on which of the respective selected talkgroups is the highest priority talkgroup. For example, such a highest priority talkgroup may be associated with a high priority incident, such as an on-going bank robbery, and the like. In a particular example, the remote communication device 117 may comprise a terminal at a dispatch center operated by a dispatcher (or the remote communication device 117 may be similar to the communication devices 106), who may assign “Talkgroup 1” to an incident, and assign a high priority to the incident and/or the talkgroup, and an indication of such may be broadcast on the network 112, transmitted to the hub device 102, and/or stored at the records 116. Hence, in these examples, the hub device 102 may choose “Talkgroup 1” as a highest priority talkgroup.

Furthermore, selection of a main talkgroup may occur using a priority scheme, and the like. For example, selection of a main talkgroup based on rank may be prioritized over selection of a main talkgroup based on numbers of associated communication devices 106, and/or selection of a main talkgroup based on a highest priority talkgroup may be prioritized over selection of a main talkgroup based on rank and/or numbers of associated communication devices 106.

However, any suitable information and/or scheme may be used to choose a main talkgroup.

Furthermore, as a number of the communication devices 106 in communication with the hub device 102 changes (e.g., such as may occur when the fourth communication device 106-4 connects to the hub device 102, or a user 110-1, 110-2, 110-3 leaves the vehicle 103 such that their respective communication device 106 disconnects from the hub device 102), the hub device 102 may dynamically change a main talkgroup from a previously chosen selected talkgroup to another currently chosen selected talkgroup. In these examples, a dynamic change of the main talkgroup may be based on any of the information described herein. For example, presuming the fourth communication device 106-4 connects to the hub device 102, the fourth communication device 106-4 may be associated with a “Talkgroup 4”, and the fourth user 110-4 may have a higher rank than the other users 110-1, 110-2, 110-3, and/or the hub device 102 may determine that “Talkgroup 4” has a higher priority than the other talkgroups identified by the talkgroup identifiers 122.

As such, when a call is received on the main talkgroup, for example after the dynamic changing of the main talkgroup, the hub device 102 may generally: control speakers 108, of respective communication devices 106 (e.g., which may be as few as one communication device 106) associated with the main talkgroup, to mute; and provide audio of the call via the hub device speaker 104. In this manner, audio of the main talkgroup may be provided at the hub device speaker 104, and not at speakers 108 of communication devices 106 of the main talkgroup, thereby reducing and/or eliminating the aforementioned howl. Put another way, audio of the main talkgroup may be provided at one speaker within the vehicle 103, and in particular the hub device speaker 104.

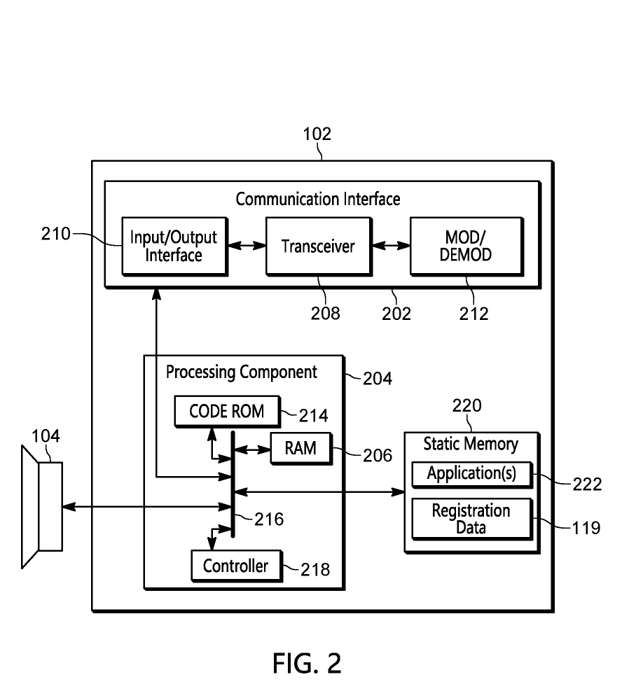

Attention is next directed to FIG. 2, which depicts a schematic block diagram of an example of the hub device 102. While the hub device 102 is depicted in FIG. 2 as a single component, the hub device 102 may be distributed among a plurality of components. Furthermore, the functionality of the hub device 102 may be implemented by a communication device 106; put another way, in some examples, the hub device 102 may comprise a vehicle hub communication device. In other examples, the hub device 102 may comprise one of the communication devices 106 that is present in the vehicle 103; in such examples, the hub device speaker 104 may comprise a speaker 108 of a respective communication device 106.

In examples where the hub device 102 may comprise one of the communication devices 106 that is present in the vehicle 103, the communication devices 106 may negotiate to determine which of the communication devices 106 is operate as the hub device 102 using any suitable criteria, such as an associated user 110 of a communication device 106 designated as the hub device 102 having a highest rank, or lowest rank.

As shown in FIG. 2, the hub device 102 includes a communication interface 202 communicatively coupled to the common data and address bus 216 of the processing component 204. The processing component 204 may include the code Read Only Memory (ROM) 214 coupled to the common data and address bus 216 for storing data for initializing system components. The processing component 204 may further include the controller 218 coupled, by the common data and address bus 216, to the Random-Access Memory 206 and the static memory 220.

As depicted, the hub device speaker 104, which may be external or internal to the hub device 102, is communicatively coupled to components of the hub device 102 via the common data and address bus 216.

While not depicted, the hub device 102 may include, and/or be communicatively coupled to, any suitable input devices and/or output devices, including, but not limited to, an RSM (e.g., the hub device speaker 104 may be component of such an RSM), a microphone, a display screen, a keyboard, a point device, buttons (e.g., such as a talkgroup selection button and/or a PTT button), and the like.

As depicted, the memory 220 further stores the registration data 119. While not depicted, the memory 220 may optionally comprise at least a portion of the records 116.

The communication interface 202 may include one or more wired and/or wireless input/output (I/O) interfaces 210 that are configurable to communicate with other suitable components of the system 100.

For example, the communication interface 202 may include one or more transceivers 208 and/or wireless transceivers for communicating with other suitable components of the system 100. Hence, the one or more transceivers 208 may be adapted for communication with one or more communication links and/or communication networks used to communicate with the other components of the system 100, including, but not limited to, the network 112 and the local communication links 118. For example, the one or more transceivers 208 may be adapted for communication with one or more of the Internet, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3^{rd} Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network.

Hence, the one or more transceivers 208 may include, but are not limited to, a cell phone transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device. In some examples, the controller 218 and/or the hub device 102 is not a generic controller and/or a generic device, but a device specifically configured to implement functionality for muting speakers of communication devices of a main talkgroup when providing audio via a hub device. For example, in some examples, the hub device 102 and/or the controller 218 specifically comprises a computer executable engine configured to implement functionality for muting speakers of communication devices of a main talkgroup when providing audio via a hub device.

The static memory 220 comprises a non-transitory machine readable medium that stores machine readable instructions to implement one or more programs or applications and/or program code. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the hub device 102 as described herein are maintained, persistently, at the memory 220 and used by the controller 218, which makes appropriate utilization of volatile storage during the execution of such programming instructions.

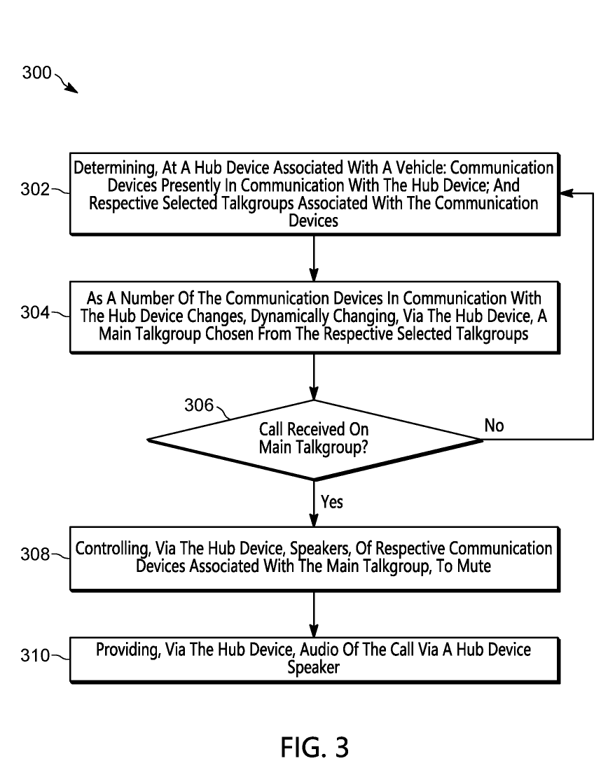

In particular, the memory 220 stores instructions and/or program code and/or a set of instructions corresponding to the at least one application 222 that, when executed by the controller 218, enables the controller 218 to implement functionality for muting speakers of communication devices of a main talkgroup when providing audio via a hub device, including but not limited to, the blocks of the method set forth in FIG. 3.

Put another way, the memory 220 may comprise a (e.g., non-transitory) computer-readable storage medium having stored thereon program instructions that, when executed by the controller 218, cause the controller 218 to perform a set of operations comprising the blocks of the method set forth in FIG. 3

The application 222 may include programmatic algorithms, and the like, to implement functionality as described herein. Alternatively, and/or in addition to programmatic algorithms, the application 222 may include one or more machine learning algorithms to implement functionality as described herein. In particular, such programmatic algorithms and/or machine learning algorithms may be used to choose a main talkgroup based, for example, any suitable criteria including, but not limited to, criteria described herein such as the aforementioned selection of a main talkgroup based on rank prioritized over selection of a main talkgroup based on numbers of associated communication devices 106, and/or selection of a main talkgroup based on a highest priority talkgroup prioritized over selection of a main talkgroup based on rank and/or numbers of associated communication devices 106. When one or more machine learning algorithm are used to implement such functionality, the one or more machine learning algorithm may be trained to choose a talkgroup based on such criteria and/or any other suitable criteria indicated, for example, by appropriate (positive and/or negative) training data.

While details of the communication devices 106 are not depicted, the communication devices 106 may have a structure similar to that depicted in FIG. 2, but adapted for respective functionality thereof.

Attention is now directed to FIG. 3, which depicts a flowchart representative of a method 300 for muting speakers of communication devices of a main talkgroup when providing audio via a hub device. The operations of the method 300 of FIG. 3 correspond to machine readable instructions that are executed by the controller 218 and/or the hub device 102. In the illustrated example, the instructions represented by the blocks of FIG. 3 are stored at the memory 220 for example, as the application 222. The method 300 of FIG. 3 is one way in which the controller 218 and/or the hub device 102 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps". The method 300 of FIG. 3 may be implemented on variations of the system 100 of FIG. 1, as well.

Furthermore, in the description of the method 300, reference is made to at least one computing device performing the method 300 as functionality indicated by the method 300 may be performed in a distributed manner.

It is furthermore understood in the description of the method 300 that the hub device 102 is associated with a vehicle, such as the vehicle 103. Indeed, the hub device 102 may comprise a vehicle hub communication device, or one of the communication devices 106 that is present in the vehicle 103.

At a block 302, the controller 218, and/or the hub device 102, determines communication devices 106 presently in communication with the hub device 102; and respective selected talkgroups associated with the communication devices 106.

At a block 304, as a number of the communication devices 106 in communication with the hub device 102 changes, the controller 218, and/or the hub device 102, dynamically changes a main talkgroup chosen from the respective selected talkgroups. For example, such dynamic changing may be based on information associated with one or more of: the communication devices 106; the respective selected talkgroups; and users 110 associated with the communication devices 106.

It is further understood that the number of the communication devices 106 in communication with the hub device 102 may increase or decrease. For example, the number of the communication devices 106 in communication with the hub device 102 may increase when the fourth user 110-4 approaches the vehicle 103 and/or enters the vehicle 103 with the fourth communication device 106-4. Conversely, the number of the communication devices 106 in communication with the hub device 102 may decrease when a user 110 exits with a respective communication device 106 and/or moves the respective communication device 106 outside a communication range of the hub device 102 (e.g., within which the local communication links 118 may be established).

In some examples the method 300 may further comprise the controller 218, and/or the hub device 102 receiving the information of the block 304 from one or more of the communication devices 106, the remote communication device 117 and/or the memory 114

For example, the information may comprise respective numbers of the communication devices 106 associated with respective selected talkgroups, and the main talkgroup may be chosen based on which of the respective selected talkgroups is associated with a highest number of the communication devices 106.

Alternatively, or in addition, the information may comprise ranks of the users 110, and the main talkgroup may be chosen based on an associated user 110 having a highest rank.

Alternatively, or in addition, the information may comprise an indication of a highest priority talkgroup, and the main talkgroup may be chosen based on which of the respective selected talkgroups is the highest priority talkgroup.

At a block 306, the controller 218, and/or the hub device 102, determines when a call is received on the main talkgroup. For example, a call may be received on the main talkgroup from any communication device, including, but not limited to, any of the communication devices 106 associated with the main talkgroup, or any other communication device associated with the main talkgroup in communication with the network 112, including, but not limited to, the remote communication device 117.

When there is no call (e.g., a “NO” decision at the block 306), the controller 218, and/or the hub device 102, may continue to determine the communication devices 106 in communication with the hub device 102 and respective selected talkgroups, and dynamically change the main talkgroup, at the block 302 and the block 304.

When a call is received on the main talkgroup (e.g., a “YES” decision at the block 306), at a block 308, the controller 218, and/or the hub device 102: controls speakers 108, of respective communication devices 106 associated with the main talkgroup, to mute.

Furthermore, when a call is received on the main talkgroup (e.g., a “YES” decision at the block 306), at a block 310, the controller 218, and/or the hub device 102: provides audio of the call via the hub device speaker 104.

The method 300 may include any other suitable features.

For example, the method 300 may further comprise, when an initial call is received on an initially chosen main talkgroup, prior to the number of the communication devices 106 changing, the controller 218, and/or the hub device 102: controlling respective speakers 108 of a respective communication device 106 to mute; providing respective audio of the initial call via the hub device speaker 104; and when another selected talkgroup is chosen as the main talkgroup while the initial call is ongoing (e.g., at the block 304), forcing respective audio of the initial call to be provided at one or more speakers 108 of a respective communication device 106 associated with the initially chosen main talkgroup; and providing the audio of the call via the hub device speaker 104. Alternatively, when another selected talkgroup is chosen as the main talkgroup while the initial call is ongoing (e.g., at the block 304), the controller 218, and/or the hub device 102, may force respective audio of the initial call to be provided at one or more of a headset 109 and an earpiece associated with the respective communication device 106 associated with the initially chosen main talkgroup.

In this manner, audio of a call on an initially chosen main talkgroup may change from being provided at the hub device speaker 104, to speakers 108 or a headset 109 (or an earpiece) of a respective communication device 106 (e.g., all the respective communication devices 106) associated with the initially chosen main talkgroup, when the main talkgroup changes to another selected talkgroup. However, such a change may occur only when a call is received on the main talkgroup (e.g., for example at the block 306) after the main talkgroup changes (e.g., at the block 304).

In other examples, the method 300 may further comprise, when respective audio of an initial call on a given selected talkgroup, different from the main talkgroup that is chosen (e.g., at the block 304), is being provided via the hub device speaker 104 when the call is received (e.g., at the block 306), the controller 218, and/or the hub device 102: forcing the respective audio of the initial call to be provided at one or more speakers 108 of a respective communication device 106 associated with the given selected talkgroup; and providing the audio of the call via hub device speaker 104. Alternatively, when respective audio of an initial call on a given selected talkgroup, different from the main talkgroup that is chosen (e.g., at the block 304), is being provided via the hub device speaker 104 when the call is received, the controller 218, and/or the hub device 102, may force respective audio of the initial call to be provided at one or more of a headset 109 and an earpiece associated with the respective communication device 106 associated with the given selected talkgroup.

In this manner, audio of a call on any talkgroup may change from being provided at the hub device speaker 104, to speakers 108 or a headset 109 (or an earpiece) of a respective communication device 106 (e.g., all the respective communication devices 106) associated with the initially chosen main talkgroup, when the main talkgroup changes to another selected talkgroup. However, such a change may occur only when a call is received on the main talkgroup (e.g., for example at the block 306) after the main talkgroup changes (e.g., at the block 304).

Indeed, such an example illustrates that audio of calls of talkgroups, other than a main talkgroup, may be provided at the hub device speaker 104, presuming no call is received on the main talkgroup.

In other examples, the method 300 may further comprise, during the call on the main talkgroup (e.g., of the block 308 and the block 310), when a respective call is received on a further selected talkgroup, different from the main talkgroup, associated with a further communication device 106, the controller 218, and/or the hub device 102: forcing the respective call to be provided at one or more of a headset 109 and an earpiece associated with the further communication device 106.

For example, forcing calls to be provided at one or more of a headset 109 and an earpiece associated with a communication device 106 may prevent audio from a respective call that is not on a main talkgroup from being received at microphones of communication devices 106 of the main talkgroup, which may prevent interference of audio from the respective call from interfering with audio of the main talkgroup.

Furthermore, determining one or more of: the communication devices 106 in communication with the hub device 102 (e.g., at the block 302); the respective selected talkgroups associated with the communication devices 106 (e.g., at the block 302); and changes to the number of the communication devices 106 (e.g., at the block 304) may comprise: receiving, from the communication devices 106, connection information, such as the registration data 119.

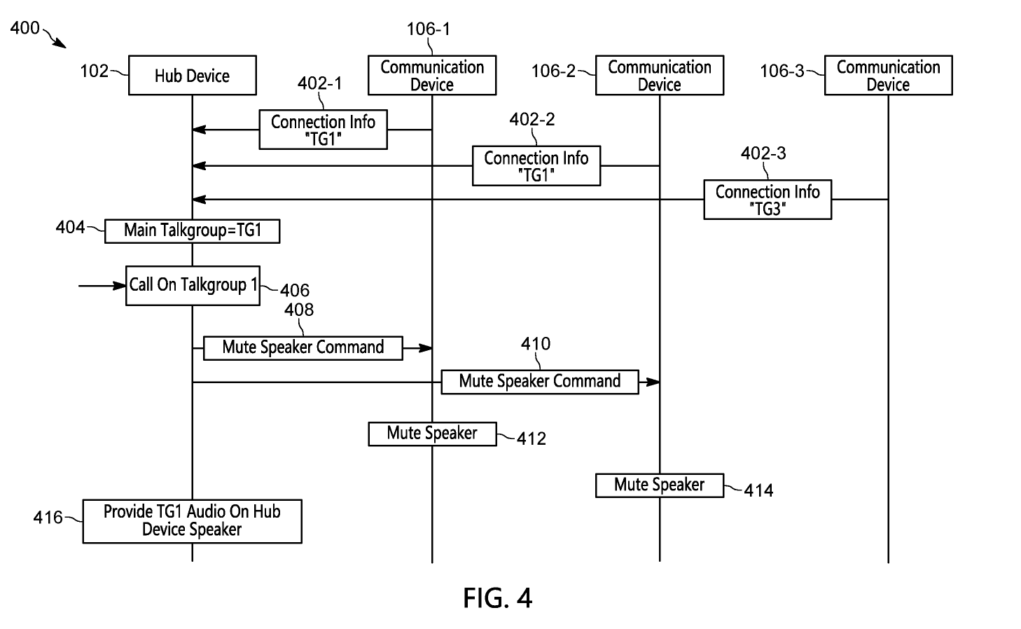

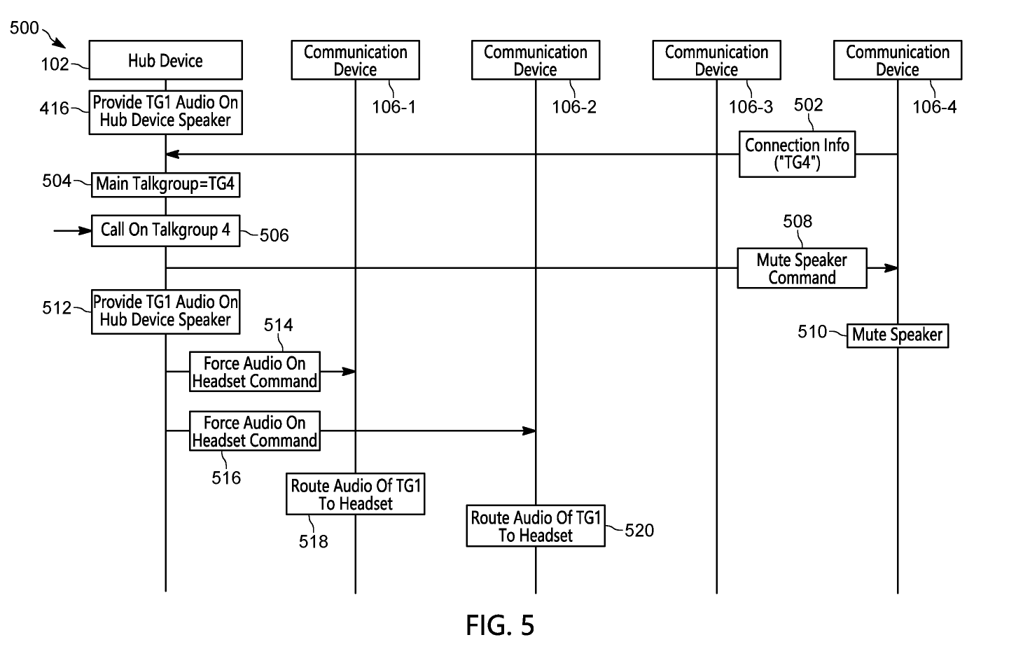

Further aspects of the method 300 are next described with respect to FIG. 4 and FIG. 5, which depict signal flow between the hub device 102 and the communication devices 106.

Attention is next directed to FIG. 4, which depicts a signal flow diagram 400 that may occur when the communication devices 106-1, 106-2, 106-3 connect to the hub device 102, and prior to the fourth communication device 106-4 connecting with the hub device 102.

As depicted, the communication devices 106-1, 106-2, 106-3, when connecting to the hub device 102, provide respective connection information 402-1, 402-2, 402-3 (e.g., and/or respective registration data 119) to the hub device 102, for example via local communication links 118. As depicted the connection information 402-1, 402-2, 402-3 includes respective talkgroups identifiers 122 of “TG1”, “TG1”, “TG3” indicating respective selected talkgroups at the communication devices 106-1, 106-2, 106-3. While not depicted, the respective connection information 402-1, 402-2, 402-3 may include respective device identifiers 120 and/or respective user identifiers 124. The hub device 102 may use the connection information 402-1, 402-2, 402-3 to populate the registration data 119 depicted in FIG. 1. The respective connection information 402-1, 402-2, 402-3 may further include any suitable requests for connecting to the hub device 102, and while not depicted, the hub device 102 may respond with suitable confirmations of respective connections.

Once the communication devices 106-1, 106-2, 106-3 are connected and registered with the hub device 102, the hub device 102 may act as a proxy communication device for the communication devices 106-1, 106-2, 106-3 for talkgroup communications.

As depicted, the hub device 102 may process the connection information 402-1, 402-2, 402-3 and choose 404 the talkgroup “Talkgroup 1” as the main talkgroup for example based on “Talkgroup 1” being associated with a highest number of the communication devices 106-1, 106-2, 106-3.

As depicted, the hub device 102 receives 406 a call on “Talkgroup 1” and responsively provides respective mute speaker commands 408, 410 to the communication devices 106-1, 106-2 associated with “Talkgroup 1”.

The communication devices 106-1, 106-2 receive the respective mute speaker commands 408, 410 and responsively mute 412, 414 their respective speakers 108.

The hub device 102 further provides 416 audio of “Talkgroup 1” at the hub device speaker 104.

While not depicted, the hub device 102 may further relay audio received at microphones of the communication devices 106-1, 106-2 to the “Talkgroup 1”, for example via local communication links 118.

Attention is next directed to FIG. 5, which depicts a signal flow diagram 500 may occur after the signal flow diagram 400 occurs. Put another way, at the signal flow diagram 500 it is understood that the hub device 102 continues to provide 416 audio of “Talkgroup 1” at the hub device speaker 104.

However, while the call of “Talkgroup 1” is ongoing, the fourth communication device 106-4 connects to the hub device 102 (e.g., the fourth user 110-4 may enter the vehicle 103 with the fourth communication device 106-4), providing respective connection information 502 (e.g., and/or registration data 119) to the hub device 102, for example via a local communication link 118. As depicted the connection information 502 includes a respective talkgroups identifiers 122 of “TG4”, indicating a talkgroup of “Talkgroup 4” is selected at the communication device 106-4. While not depicted, the connection 502 may include a respective device identifier 120 of the communication device 106-4 and/or a respective user identifier 124 of the fourth user 110-4.

It is understood that, in the depicted example, the hub device 102 determines (e.g., at the block 302 of the method 300) the communication devices 106 presently in communication with the hub device 102, and respective selected talkgroups associated with the communication devices 106, via receipt of the connection information 402-1, 402-2, 402-3, 502,

As depicted, the hub device 102 may process the connection information 402-1, 402-2, 402-3, 502, and choose 504 the talkgroup “Talkgroup 4” as the main talkgroup for example based on “Talkgroup 4” being associated with a rank of the fourth user 110-4 being a highest rank of the users 110. Put another way, the hub device 102 dynamically changes (e.g., at the block 304 of the method 300) the main talkgroup from “Talkgroup 1” to “Talkgroup 4”.

Regardless, audio of “Talkgroup 1” may continue to be provided at the hub device speaker 104 until a call is received 506 (e.g., a “YES” decision at the block 306 of the method 300) on the main talkgroup of “Talkgroup 4”.

In response to receiving a call on the main talkgroup of “Talkgroup 4”, the hub device 102 provides (e.g., at the block 308 of the method 300) a mute speaker command 508 to the communication device 106-4 associated with “Talkgroup 4”, and the communication device 106-4 receives the mute speaker command 508 and responsively mutes 510 the speaker 108-4.

The hub device 102 further provides 512 audio of “Talkgroup 4” at the hub device speaker 104 (e.g., at the block 310 of the method 300).

While not depicted, the hub device 102 may further relay audio received at microphone of the fourth communication device 106-4 to the “Talkgroup 4”, for example via a local communication link 118.

However, presuming the call on “Talkgroup 1” is ongoing, the hub device 102 does not provide audio from both “Talkgroup 1” and “Talkgroup 4” at the hub device speaker 104.

Rather, as depicted, the hub device 102 provides respective commands 514, 516 to the communication devices 106-1, 106-2 of “Talkgroup 1” to force audio of “Talkgroup 1” to be provided at respective headsets 109-1, 109-2. The communication devices 106-1, 106-2 receive the commands 514, 516 and respectively routes 518, 520 audio of “Talkgroup 1” to their respective headsets 109-1, 109-2. Alternatively, the commands 514, 516 may be to force audio of “Talkgroup 1” to be provided at respective speakers 108-1, 108-2.

While not depicted, the hub device 102 may further relay audio of “Talkgroup 1” to the communication devices 106-1, 106-2 for output at their respective headsets 109-1, 109-2.

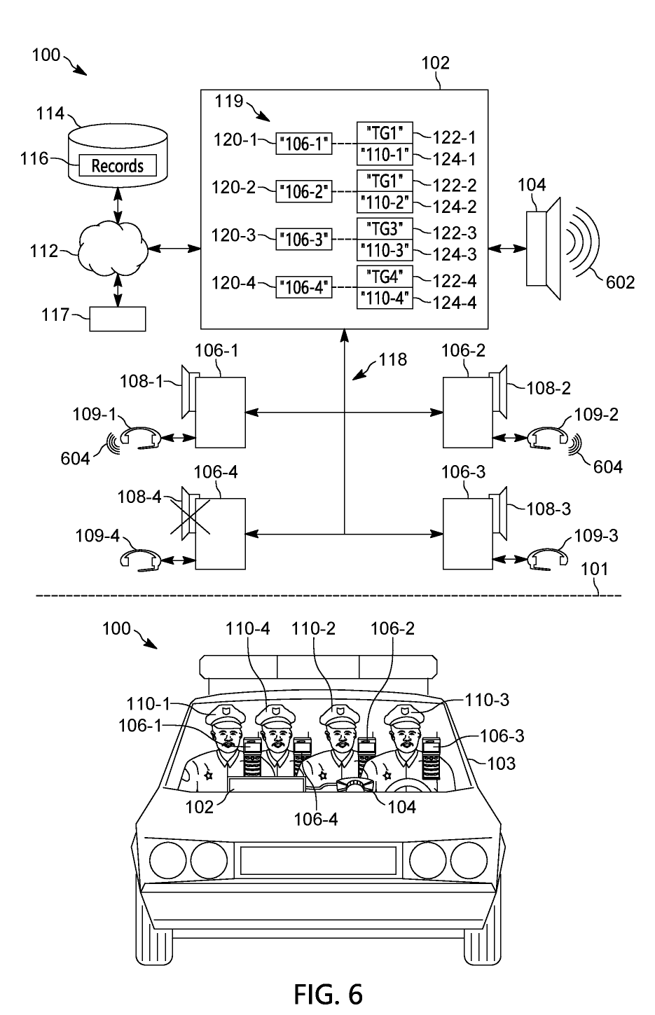

Attention is next directed to FIG. 6, which depicts the system 100 after actions of the signal flow diagrams 400, 500 have been implemented.

In particular, the fourth communication device 106-4 has connected to the hub device 102, for example as the fourth user 110-4 has moved the fourth communication device 106-4 to within a communication range of the hub device 102 (e.g., over which the local communication links 118 may be established) and entered the vehicle 103. The connection information 502 is now stored at the hub device 102 in the registration data 119 as a device identifier 120-4 of the fourth communication device 106-4 (e.g., “106-4”) in association with a talkgroup identifier 122-4 (e.g., “TG4) of “Talkgroup 4” selected at the fourth communication device 106-4, and in further association with a user identifier 124-4 (e.g., “110-4”) of the fourth user 110-4.

As depicted, the speaker 108-4 is muted, as indicated by an “X” through the speaker 108-4, and audio 602 of “Talkgroup 4” is being provided at the hub device speaker 104.

Furthermore, audio 604 of “Talkgroup 1” is being provided at the respective headsets 109-1, 109-2 of the communication devices 106-1, 106-2.

Yet further alternatives are within the scope of the present specification.

For example, while in FIG. 6 the fourth user 110-4 is depicted as being inside the vehicle 103 operating the fourth communication device 106-4, in other examples the fourth user 110-4 may be adjacent the vehicle 103 (e.g., inside the given range of the hub device 102) and operate the fourth communication device 106-4.

In some examples, the method 300 may include the hub device 102 determining whether or not the users 110 are inside or outside the vehicle 103, and connections (e.g., a local communication link 118) with a communication device 106 may occur only when a respective user 110, and the respective communication devices 106, are inside the vehicle 103. Conversely, in these examples, the method 300 may include the hub device 102 determining whether a user 110 that was previously inside the vehicle 103 is now outside the vehicle 103, and end an existing connection (e.g., a local communication link 118) with a respective communication device 106 accordingly.

Such a determination may occur in any suitable manner, and may include, but is not limited to, the hub device 102 being communicatively coupled with occupant sensor devices of the vehicle 103 (e.g., pressure sensors incorporated into seats of the vehicle 103), and the hub device 102 searching for a new communication device 106 when a new user 110 is detected via such occupant sensors and register a new communication device 106 in association with a respective seat in the vehicle 103. When an associated occupant sensor device indicates the user 110 at that location has left the vehicle 103, the hub device 102 may disconnect from the associated communication device 106.

However, such a determination may occur in any suitable manner. For example, when a communication device 106 is registering with the hub device 102, a communication device 106 may provide respective location coordinates (e.g., determined using a respective global positioning system device, and the like), and the hub device 102 may determine, from the respective location coordinates whether the communication device 106 is inside or outside the vehicle 103 using a geofence around the vehicle 103 (e.g., the hub device 102 may also determine, using a respective global positioning system device, and the like, a location of the vehicle 103 and a (e.g., moving) geofence relative to the location of the vehicle 103.

Hence, when a communication device 106 is registering with the hub device 102 and the communication device 106 is outside the geofence, the registration and connection may be denied or the communication device 106 may connect to the hub device 102, but a speaker of the communication device 106 may not be muted via the method 300, as the communication device 106 is determined to be outside the vehicle 103. Conversely, when a communication device 106 is registering with the hub device 102 is and the communication device 106 is inside the geofence, the registration and connection may be accepted, and a speaker of the communication device 106 may be muted via the method 300 as described herein.

Furthermore, prior to a speaker 108 being muted and/or audio being routed to a headset 109, a notification thereof may be provided at respective communication device 106, for example at respective display screen thereof. In some of these examples, the notification may include an electronic button, and the like, for accepting or denying the speaker 108 being muted and/or audio being routed to the headset 109, which may interrupt the method 300 and/or cause the method 300 to end. Alternatively, when a command is received to force audio to be routed to a speaker 108 or a headset 109, a communication device 106 may provide a graphic user interface that allows a respective user 110 to select whether to route the audio to a respective speaker 108 or a respective headset 109.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot route audio of talkgroups, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions and/or program code (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions and/or program code, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the "C" programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
determining, at a hub device associated with a vehicle: communication devices presently in communication with the hub device; and respective selected talkgroups associated with the communication devices;
as a number of the communication devices in communication with the hub device changes, dynamically changing, via the hub device, a main talkgroup chosen from the respective selected talkgroups based on information associated with one or more of:
the communication devices;
the respective selected talkgroups; and
users associated with the communication devices; and
when a call is received on the main talkgroup:
controlling, via the hub device, speakers, of respective communication devices associated with the main talkgroup, to mute; and
providing, via the hub device, audio of the call via a hub device speaker.

2. The method of claim 1, wherein the information comprises respective numbers of the communication devices associated with respective selected talkgroups, and
wherein the main talkgroup is chosen based on which of the respective selected talkgroups is associated with a highest number of the communication devices.

3. The method of claim 1, wherein the information comprises ranks of the users, and
wherein the main talkgroup is chosen based on an associated user having a highest rank.

4. The method of claim 1, wherein the information comprises an indication of a highest priority talkgroup, and
wherein the main talkgroup is chosen based on which of the respective selected talkgroups is the highest priority talkgroup.

5. The method of claim 1, wherein determining one or more of: the communication devices in communication with the hub device; the respective selected talkgroups associated with the communication devices; and changes to the number of the communication devices comprises:
receiving, from the communication devices, connection information.

6. The method of claim 1, further comprising receiving the information from one or more of the communication devices and a remote communication device.

7. The method of claim 1, further comprising:
when an initial call is received on an initially chosen main talkgroup, prior to the number of the communication devices changing: controlling respective speakers of a respective communication device to mute;
providing, via the hub device, respective audio of the initial call via the hub device speaker;
when another selected talkgroup is chosen as the main talkgroup while the initial call is ongoing, forcing respective audio of the initial call to be provided at one or more of speakers, a headset and an earpiece of a respective communication device associated with the initially chosen main talkgroup; and
providing the audio of the call via the hub device speaker.

8. The method of claim 1, further comprising, when respective audio of an initial call on a given selected talkgroup, different from the main talkgroup that is chosen, is being provided via the hub device speaker when the call is received:
forcing the respective audio of the initial call to be provided at one or more of speakers, a headset and an earpiece of a respective communication device associated with the given selected talkgroup; and
providing the audio of the call via the hub device speaker.

9. The method of claim 1, further comprising, during the call on the main talkgroup, when a respective call is received on a further selected talkgroup, different from the main talkgroup, associated with a further communication device:
forcing the respective call to be provided at one or more of a headset and an earpiece associated with the further communication device.

10. The method of claim 1, wherein the hub device comprises a vehicle hub communication device, or one of the communication devices that is present in the vehicle.

11. A hub device associated with a vehicle, the hub device comprising:
a controller; and
a computer-readable storage medium having stored thereon program instructions that, when executed by the controller, causes the controller to perform a set of operations comprising:
determining: communication devices presently in communication with the hub device; and respective selected talkgroups associated with the communication devices;
as a number of the communication devices in communication with the hub device changes, dynamically changing a main talkgroup chosen from the respective selected talkgroups based on information associated with one or more of:
the communication devices;
the respective selected talkgroups; and
users associated with the communication devices; and
when a call is received on the main talkgroup:
controlling speakers, of respective communication devices associated with the main talkgroup, to mute; and
providing audio of the call via a hub device speaker.

12. The hub device of claim 11, wherein the information comprises respective numbers of the communication devices associated with respective selected talkgroups, and
wherein the main talkgroup is chosen based on which of the respective selected talkgroups is associated with a highest number of the communication devices.

13. The hub device of claim 11, wherein the information comprises ranks of the users, and
wherein the main talkgroup is chosen based on an associated user having a highest rank.

14. The hub device of claim 11, wherein the information comprises an indication of a highest priority talkgroup, and
wherein the main talkgroup is chosen based on which of the respective selected talkgroups is the highest priority talkgroup.

15. The hub device of claim 11, wherein determining one or more of: the communication devices in communication with the hub device; the respective selected talkgroups associated with the communication devices; and changes to the number of the communication devices comprises:
receiving, from the communication devices, connection information.

16. The hub device of claim 11, wherein the set of instructions further comprises: receiving the information from one or more of the communication devices and a remote communication device.

17. The hub device of claim 11, wherein the set of instructions further comprises:
when an initial call is received on an initially chosen main talkgroup, prior to the number of the communication devices changing: controlling respective speakers of a respective communication device to mute;
providing respective audio of the initial call via the hub device speaker;
when another selected talkgroup is chosen as the main talkgroup while the initial call is ongoing, forcing respective audio of the initial call to be provided at one or more of speakers, a headset and an earpiece of a respective communication device associated with the initially chosen main talkgroup; and
providing the audio of the call via the hub device speaker.

18. The hub device of claim 11, wherein the set of instructions further comprises, when respective audio of an initial call on a given selected talkgroup, different from the main talkgroup that is chosen, is being provided via the hub device speaker when the call is received:
forcing the respective audio of the initial call to be provided at one or more of speakers, a headset and an earpiece of a respective communication device associated with the given selected talkgroup; and
providing the audio of the call via the hub device speaker.

19. The hub device of claim 11, wherein the set of instructions further comprises, during the call on the main talkgroup, when a respective call is received on a further selected talkgroup, different from the main talkgroup, associated with a further communication device:
forcing the respective call to be provided at one or more of a headset and an earpiece associated with the further communication device.

20. The hub device of claim 11, further comprising: a vehicle hub communication device; or one of the communication devices that is present in the vehicle.
